(19) United States
(12) Patent Application Publication
(10) Pub. No.: US 2026/0366695 A1
(43) Pub. Date: Nov. 19, 2026

(54) LIGHTING DEVICE FOR A MOTOR VEHICLE

(71) Applicant: HELLA GMBH & CO. KGAA, Lippstadt (DE)

(72) Inventors: Lukas Langer, Bochum (DE); Wolf Alexander Quitsch, Beckum (DE)

(21) Appl. No.: 19/675,933

(22) Filed: May 13, 2026

(30) Foreign Application Priority Data
May 16, 2025 (DE) 102025118989.7

(51) Int. Cl. F21S 43/00

(52) U.S. Cl. CPC F21S 43/601

(57) ABSTRACT

A lighting device for a motor vehicle is provided. The lighting device includes a light source, a first LC display, and a second LC display. Light enters the first LC display, exits the first LC display, enters the second LC display, and exits the second LC display. The first LC display has a plurality of first segments, and the second LC display has a plurality of second segments. The first segments have a longitudinal direction and a transverse direction, with an extent in the longitudinal direction greater than in the transverse direction, and the second segments have a longitudinal direction and a transverse direction, with an extent in the longitudinal direction greater than in the transverse direction. The longitudinal direction of the first segments forms an angle with the longitudinal direction of the second segments that is not equal to 0° or 180°.

### CROSS-REFERENCE TO RELATED APPLICATIONS

This application claims priority to German Patent Application 10-2025-118-989.7, filed May. 16, 2025, the disclosure of which is incorporated by reference.

### FIELD OF THE INVENTION

The present invention relates to a lighting device for a motor vehicle.

### BACKGROUND OF THE INVENTION

A lighting device of the above-mentioned type is known from WO 2023/025626 A1. The lighting device described therein comprises a lighting module that has at least one light source and a light-emitting surface illuminated by the light source, from which light is emitted during operation of the lighting device, and an LC display that is arranged at least partially in front of the light-emitting surface in such a way that during operation of the lighting device at least one portion of the light emerging from the light-emitting surface enters an entry surface of the LC display and emerges from an exit surface of the LC display, wherein the lighting device is set up such that the LC display is controlled in order to selectively allow portions of the light incident on the entry surface to pass through the LC display and to prevent other portions of the light incident on the entry surface from passing through the LC display.

The backlighting of such an LC display is usually realized either by planar backlighting or by pixelated backlighting. The segmentation of the LC display is in this case also responsible for the resolution of the overall system. A typical segmentation of an LC display 30 from the prior art is shown in FIG. 9. The segments 31 of this LC display 30 have a square shape. The addressing of the individual segments is realized by corresponding driver electronics. As a rule, the aim is to display more complex signatures and/or lettering, so that several hundred segments have to be addressed. The control system and the associated use of electronic components represent a correspondingly high cost factor in the overall system. In the case of planar backlighting, there is the additional complication that an individual segment of the LC display provides insufficiently high contrast values. This means that the relevant requirements may not be met.

### SUMMARY OF THE INVENTION

The problem underlying the present invention is therefore the creation of a lighting device of the type mentioned at the beginning, which can be manufactured comparatively cost-effectively despite a high resolution. According to the invention, this is achieved by a lighting device of the type mentioned at the beginning with the features set forth herein.

According to one embodiment, it is provided that the lighting device comprises a second LC display having an entry surface and an exit surface, wherein during operation of the lighting device at least one portion of the light emitted from the exit surface of the first LC display enters the entry surface of the second LC display and exits the exit surface of the second LC display, wherein the second LC display has a plurality of second segments that can be controlled independently of one another, wherein the first segments have a longitudinal direction and a transverse direction perpendicular thereto, wherein the extent of the first segments is greater in their longitudinal direction than in their transverse direction, wherein the second segments have a longitudinal direction and a transverse direction perpendicular thereto, wherein the extent of the second segments is greater in their longitudinal direction than in their transverse direction, and wherein the longitudinal direction of the first segments encloses an angle not equal to 0° and not equal to 180° with the longitudinal direction of the second segments. Such a design can reduce the cost of manufacturing the lighting device while maintaining the same resolution of the overall system, because the number of required electronic components and the control effort can be reduced. Furthermore, higher contrast values can be achieved with this design. Furthermore, the arrangement of two LC displays, one behind the other, also allows gray levels to be generated.

It is possible that the lighting device is set up such that the first segments of the first LC display are controlled in order to selectively allow portions of the light impinging on the entry surface to pass through the first LC display and to prevent other portions of the light impinging on the entry surface from passing through the first LC display, and that the second segments of the second LC display are controlled in order to selectively allow portions of the light incident on the entry surface to pass through the second LC display and to prevent other portions of the light incident on the entry surface from passing through the second LC display. Furthermore, it may be provided that the lighting device is arranged such that the light emitted by the at least one light source passes successively through at least one of the first segments of the first LC display and through at least one of the second segments of the second LC display, so that a plurality of resulting segments is obtained, each of which corresponds to a superposition of at least one first segment with at least one second segment. The number of the resulting segments produced by this superposition is partly responsible for the resolution of the overall system. Furthermore, the shape of the resulting segments is also determined by the superposition.

It may be provided that the longitudinal directions of all first segments of the first LC display are aligned parallel to each other and/or that the longitudinal directions of all second segments of the second LC display are aligned parallel to each other. It may further be provided that the longitudinal direction of the first segments forms an angle of between 10° and 170° with the longitudinal direction of the second segments, in particular an angle of between 40° and 140°, preferably an angle of between 80° and 100°, for example, an angle of 90°.

It is possible that the first segments of the first LC display are formed in a strip shape, in particular are formed in a strip shape in the longitudinal direction of the first segments over the entire extent of the active surface of the first LC display, and/or that the second segments of the second LC display are formed in a strip shape, in particular are formed in a strip shape in the longitudinal direction of the second segments over the entire extent of the active surface of the second LC display. By superimposing strip-shaped segments at an angle of 90°, resulting segments having a square shape can be generated. In contrast to the prior art shown in FIG. 9 having only one LC display, an equally high resolution can be achieved with fewer electronic components and a lower control effort by superimposing strip-shaped segments of two LC displays. The LC display shown in FIG. 9 has 100 segments. In order to generate 100 resulting segments by superimposing strip-shaped segments of two LC displays, each of the two LC displays needs only to have 10 strip-shaped segments. In contrast to the prior art, where 100 segments have to be controlled separately, only 20 segments in total have to be controlled separately in the design with the superposition of strip-shaped segments of two LC displays. The difference becomes even clearer in the case of, for example, 10,000 square segments of a single LC display that have to be controlled separately. In order to generate 10,000 resulting segments by superimposing strip-shaped segments of two LC displays, each of the two LC displays needs only to have 100 strip-shaped segments, so that only a total of 200 segments have to be controlled separately. It can be seen from these examples that significantly fewer segments are sufficient to achieve a much higher resolution. As a result, the control effort can be minimized and simpler driver electronics having a lower number of channels can be used.

Alternatively, it may be provided that the first segments of the first LC display have a shape that differs from a strip shape and/or that the second segments of the second LC display have a shape that differs from a strip shape. This allows the design of the lighting device to be adapted to the respective requirements.

It is possible that the two LC displays are set up to be rotated relative to each other in such a way that the angle between the longitudinal direction of the first segments and the longitudinal direction of the second segments is changed by the rotation. This measure also increases the design freedom because the lighting device can be adapted to the specific requirements of each project.

It may be provided that at a first angle between the longitudinal direction of the first segments and the longitudinal direction of the second segments, the resulting segments have a first shape and that at a second angle between the longitudinal direction of the first segments and the longitudinal direction of the second segments, which is different from the first angle, the resulting segments have a second shape that is different from the first shape. For example, the first shape of the resulting segments can correspond to a rectangle, in particular a square, and the second shape of the resulting segments can correspond to a parallelogram, in particular a rhombus.

It is possible that each of the two LC displays has a liquid crystal layer that is arranged between two mutually opposite, at least partially transparent panes.

It may be provided that only three at least partially transparent panes are provided, wherein the liquid crystal layer of the first LC display is arranged between the first pane and the second pane, and wherein the liquid crystal layer of the second LC display is arranged between the second pane and the third pane, in particular wherein both the exit surface of the first LC display and the entry surface of the second LC display are formed on the second pane. The provision of only three panes results in a compact design of the lighting device.

Alternatively, it may be provided that four at least partially transparent panes are provided, wherein the liquid crystal layer of the first LC display is arranged between the first pane and the second pane, and wherein the liquid crystal layer of the second LC display is arranged between the third pane and the fourth pane, in particular wherein the lighting device comprises a connecting material arranged between the second pane and the third pane. This design can be manufactured more cost-effectively because commercially available LC displays can potentially be connected to each other by means of the connecting component.

It may be provided that each of the LC displays is a passive LC display, in particular wherein each of the LC displays is a smart glass display. For an automotive lighting function, small surfaces are generally used, from which a high light output or a high brightness must be achieved. Therefore, a high transmittance of the LC displays is important in order to generate the legally required luminous intensities of a signal function. In contrast to an active LC display, a passive LC display has no active components such as transistors, so that the transmittance of the passive LC display is significantly higher than that of an active LC display. With a smart glass display, no polarization filters are required, so that a higher transmittance is available, which is advantageous for fulfilling the desired lighting function. Furthermore, the LC display is also independent of the viewing angle due to the elimination of the polarizers.

It is possible that the LC display is an LC display doped with color pigments. In particular, the LC display can in this case be a so-called dye-doped display, which is doped with color pigments that determine the color of the LC display when it is not in operation.

### DESCRIPTION OF THE DRAWINGS

The invention is explained in more detail below with reference to the accompanying drawings. In the drawings:

FIG. 1 is a schematic sectional view of a first embodiment of a lighting device according to the invention;

FIG. 2 is a schematic sectional view of the first LC display of the lighting device according to FIG. 1;

FIG. 3 is a schematic top view of the segments of the first LC display of the lighting device according to FIG. 1;

FIG. 4 is a schematic top view of the segments of the second LC display of the lighting device according to FIG. 1, wherein the angle between the longitudinal direction of the first segments and the longitudinal direction of the second segments is 90°;

FIG. 5 is a schematic top view of the resulting segments of the LC displays arranged according to FIGS. 3 and 4 of the lighting device according to FIG. 1 in a non-operating state of all segments;

FIG. 6 is a schematic top view of the resulting segments of the LC displays arranged according to FIGS. 3 and 4 of the lighting device according to FIG. 1 in an operating state of all segments;

FIG. 7 is a schematic top view of the resulting segments of the LC displays arranged according to FIGS. 3 and 4 of the lighting device according to FIG. 1 in an operating state of only some of the segments;

FIG. 8 is a schematic top view of the resulting segments of the LC displays of the lighting device according to FIG. 1, arranged at an angle other than 90° in a non-operating state of all segments; and

FIG. 9 is a schematic top view of the LC display of a lighting device according to the prior art.

In the figures, identical and functionally identical parts are marked with the same reference symbols.

### DETAILED DESCRIPTION OF THE CURRENT EMBODIMENTS

The lighting devices shown in the figures comprise a light source not shown, as well as a first LC display 1 and a second LC display 1′. The first and the second LC displays 1, 1′ are substantially identical and correspond to the first LC display 1 described in detail with reference to FIG. 2.

The LC display 1 shown in FIG. 2 comprises two mutually opposite, at least partially transparent panes 2, 3, between which a liquid crystal layer 4 is arranged. This liquid crystal layer 4 contains only schematically indicated liquid crystals 5 and color pigments 6.

The LC display 1 further comprises a transparent metal oxide layer 7, in particular an ITO layer, on the inner side of each of the panes 2, 3, and an orientation layer 8 between the metal oxide layer 7 and the liquid crystal layer 4. In this case, for example, the outer side of the upper pane 2 in FIG. 2 serves as the entry surface 9 for the light emitted by the light source, whereas the outer side of the lower pane 3 in FIG. 2 serves as the exit surface 10 for the light entering through the entry surface 9.

The LC display 1 further comprises a seal 11 made of an encapsulation adhesive at each end of the liquid crystal layer 4. The LC display 1 further comprises control means 12 shown only schematically, which can be connected to the vehicle’s on-board electronics via a supply line 13.

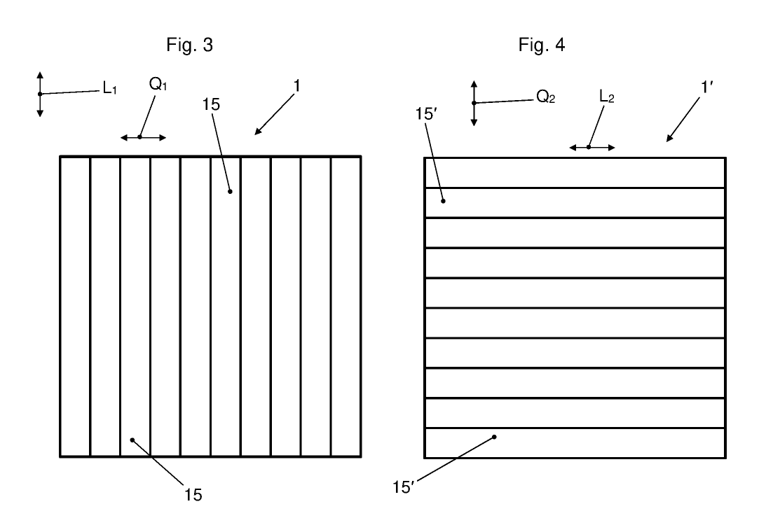

The LC display 1 is a passive LC display that is designed as a so-called smart glass display. The LC display 1 has an active surface with a plurality of separately switchable segments 15 (see FIG. 3). These are formed by regions of the metal oxide layer that can be controlled independently of each other.

In an operating state (on-state), the controlled segment 15 of the LC display 1 allows the light that has entered through the part of the entry surface 9 of the controlled segment 15 to exit at least partially, in particular for the most part, from the exit surface 10, whereas in a non-operating state (off-state), the controlled segment 15 of the LC display 1 does not allow the light that has entered through the corresponding part of the entry surface 9 to exit from the exit surface 10.

For the sake of simplicity, the reference symbols of the first LC display 1 are used for the second LC display 1′ and its parts in the drawings, the descriptions of the figures, and the claims in a version provided with a prime.

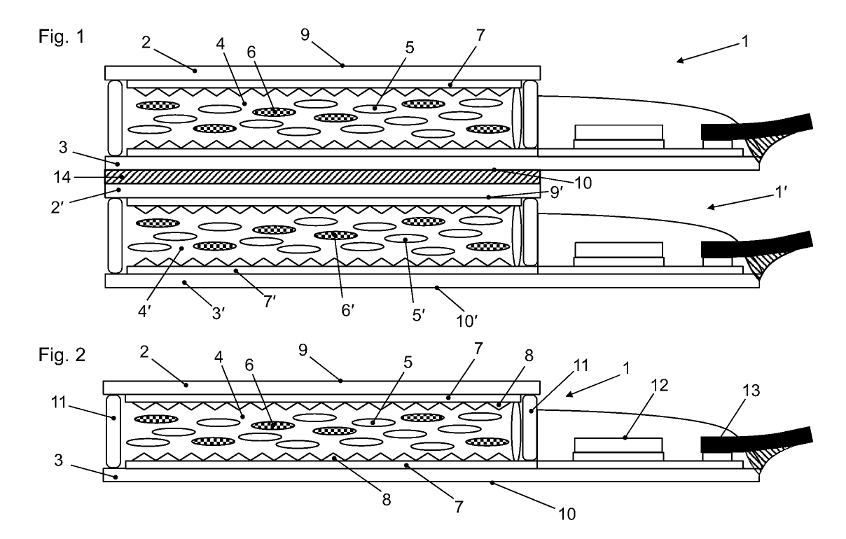

The two LC displays 1, 1′ according to FIG. 1 are arranged in the lighting device such that the light emitted by the at least one light source enters the entry surface 9 of the first LC display 1 and emerges from the exit surface 10 of the first LC display 1 and such that the light emitted from the exit surface 10 of the first LC display 1 enters the entry surface 9′ of the second LC display 1′ and emerges from the exit surface 10′ of the second LC display 1′. The four at least partially transparent panes 2, 3, 2′, 3′ are arranged one behind the other in the direction of propagation of the light emitted by the light source (see FIG. 1).

The embodiment of the lighting device shown in FIG. 1 further comprises a connecting material 14 that is arranged between the first LC display 1 and the second LC display 1′. In particular, the connecting material 14 is in contact with the underside of the second pane 3 and the upper side of the third pane 2′.

Alternatively, it is possible to use only one pane in the middle, in which case no connecting material 14 needs to be provided.

FIG. 3 illustrates that the first segments 15 of the first LC display 1 are formed in a strip shape. The first segments 15 have a longitudinal direction L₁ and a transverse direction Q₁ perpendicular to it. Due to the strip-shaped design, the extent of the first segments 15 in their longitudinal direction L₁ is significantly greater than in their transverse direction Q₁. The first strip-shaped segments 15 extend in the longitudinal direction L₁ of the segments 15 over the entire extent of the active surface of the first LC display 1.

FIG. 4 illustrates that the second segments 15′ of the second LC display 1′ are also formed in a strip shape. The second segments 15 have a longitudinal direction L₂ and a transverse direction Q₂ perpendicular to it. Due to the strip-shaped design, the extent of the second segments 15 in their longitudinal direction L₂ is significantly greater than in their transverse direction Q₂. In this case, the second strip-shaped segments 15′ extend in the longitudinal direction L₂ of the second segments 15′ over the entire extent of the active surface of the second LC display 1′.

The first and the second LC displays 1, 1′ are therefore also substantially identical in terms of their segments 15, 15′. The only difference is that the second LC display 1′ is arranged in a different orientation in the lighting device than the first LC display 1, so that the longitudinal direction L₁ of the first segments 15 and the longitudinal direction L₂ of the second segments 15′ form an angle of 90° with each other.

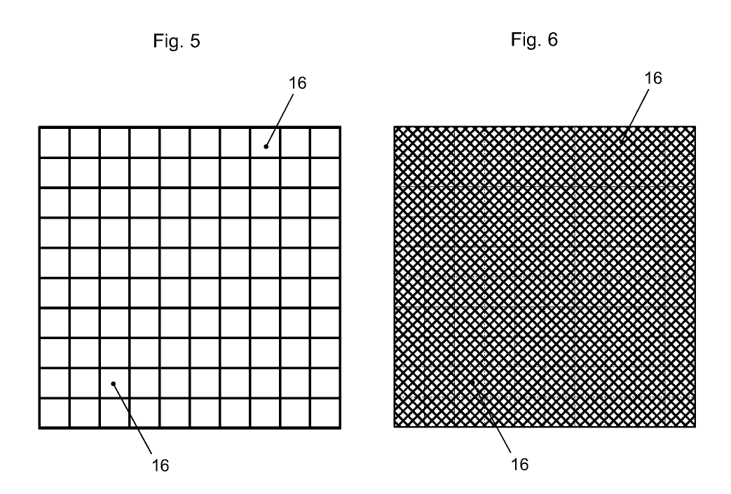

The superposition of these segments 15, 15′ oriented in this way produces the resulting segments 16 shown in FIGS. 5-7, each of which has a square shape. FIG. 5 shows the resulting segments 16 in a non-operating state, whereas FIG. 6 shows the resulting segments 16 in an operating state. In the operating state shown in FIG. 6, each of the segments 15, 15′ of the two LC displays 1, 1′ allows the light that has entered through the entry surfaces 9, 9′ to exit at least partially, in particular for the most part, from the exit surfaces 10, 10′.

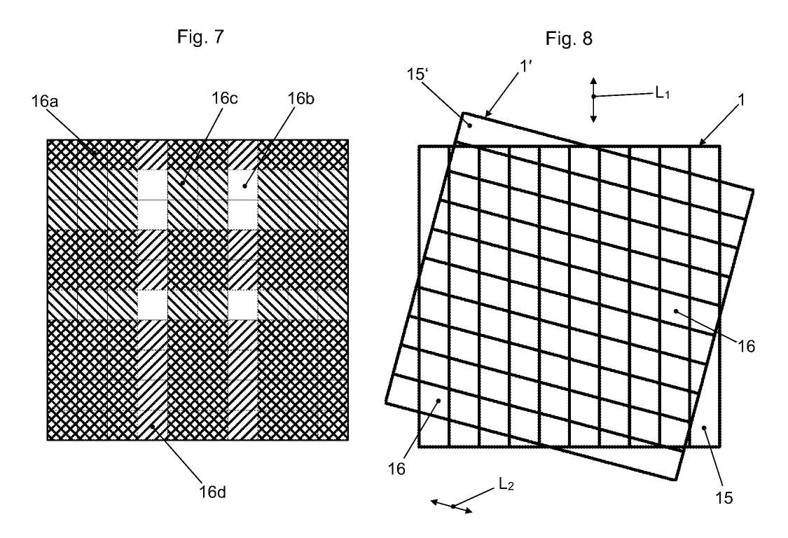

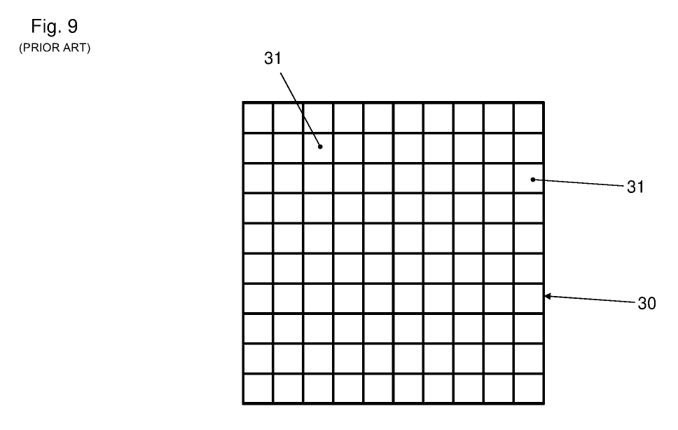

FIG. 7 shows a state in which some of the first segments 15 of the first LC display 1 are in an operating state and others of the first segments 15 of the first LC display 1 are in a non-operating state. Furthermore, some of the second segments 15′ of the second LC display 1′ are in an operating state, and others of the second segments 15′ of the second LC display 1′ are in a non-operating state.

For example, in the case of the resulting segment 16a of FIG. 7, both the corresponding strip-shaped first segment 15 of the first display 1 and the corresponding strip-shaped second segment 15′ of the second display 1′ are in an operating state. Furthermore, in the case of the resulting segment 16b of FIG. 7, both the corresponding strip-shaped first segment 15 of the first display 1 and the corresponding strip-shaped second segment 15′ of the second display 1′ are in a non-operating state.

Furthermore, in the case of the resulting segment 16c of FIG. 7, the corresponding strip-shaped first segment 15 of the first display 1 is in an operating state, whereas the corresponding strip-shaped second segment 15′ of the second display 1′ is in a non-operating state. Furthermore, in the case of the resulting segment 16d of FIG. 7, the corresponding strip-shaped first segment 15 of the first display 1 is in a non-operating state, whereas the corresponding strip-shaped second segment 15′ of the second display 1′ is in an operating state.

It is quite possible that the segments 15 of the first LC display 1 have a shape that differs from a strip shape, and/or that the segments 15′ of the second LC display 1′ have a shape that differs from a strip shape.

Furthermore, it is quite possible that the longitudinal direction L₁ of the first segments 15 and the longitudinal direction L₂ of the second segments 15′ form an angle other than 90°. An example of this can be found in FIG. 8. In the lighting device shown therein, the LC displays 1, 1′ are rotated relative to one another in such a way that the longitudinal direction L₁ of the first segments 15 and the longitudinal direction L₂ of the second segments 15′ form an angle of approximately 15° with one another. This results in segments 16 that are formed in a rhombus shape.

### LIST OF REFERENCE SIGNS

1 first LC display
2, 3 transparent panes of the first LC display
4 liquid crystal layer of the first LC display
5 liquid crystals of the first LC display
6 color pigments of the first LC display
7 metal oxide layer of the first LC display
8 orientation layer of the first LC display
9 entry surface of the first LC display
10 exit surface of the first LC display
11 seal of the liquid crystal layer of the first LC display
12 control means of the first LC display
13 supply line of the first LC display
14 connecting material
15 first segment
16 resulting segment
L₁ longitudinal direction of the first segment
Q₁ transverse direction of the first segment
1′ second LC display
2′, 3′ transparent panes of the second LC display
4′ liquid crystal layer of the second LC display
5′ liquid crystals of the second LC display
6′ color pigments of the second LC display
7′ metal oxide layer of the second LC display
9′ entry surface of the second LC display
10′ exit surface of the second LC display
15′ second segment
L₂ longitudinal direction of the second segment
Q₂ transverse direction of the second segment

The above description is that of current embodiments of the invention. Various

alterations and changes can be made without departing from the spirit and broader aspects of the invention. This disclosure is presented for illustrative purposes and should not be interpreted as an exhaustive description of all embodiments of the invention or to limit the scope of the claims to the specific elements illustrated or described in connection with these embodiments. Any reference to elements in the singular, for example, using the articles “a,” “an,” “the,” or “said,” is not to be construed as limiting the element to the singular.

1. A lighting device for a motor vehicle, comprising:
at least one light source; and
a first LC display having an entry surface and an exit surface,
wherein during operation at least a portion of light emitted by the at least one light source enters the entry surface of the first LC display and exits the exit surface of the first LC display,
wherein the first LC display has a plurality of first segments that are independently controllable,
wherein the lighting device further comprises a second LC display having an entry surface and an exit surface,
wherein during operation at least a portion of the light exiting from the first LC display enters the entry surface of the second LC display and exits the exit surface of the second LC display,
wherein the second LC display has a plurality of second segments that are independently controllable,
wherein the first segments each have a longitudinal direction and a transverse direction perpendicular thereto, with an extent in the longitudinal direction greater than in the transverse direction,
wherein the second segments each have a longitudinal direction and a transverse direction perpendicular thereto, with an extent in the longitudinal direction greater than in the transverse direction, and
wherein the longitudinal direction of the first segments forms an angle with the longitudinal direction of the second segments that is not equal to 0° and not equal to 180°.

2. The lighting device of claim 1, wherein the first segments are controlled to selectively allow portions of light incident on the entry surface of the first LC display to pass through and to prevent other portions from passing through, and wherein the second segments are controlled to selectively allow portions of light incident on the entry surface of the second LC display to pass through and to prevent other portions from passing through.

3. The lighting device of claim 1, wherein the lighting device is configured such that light emitted by the at least one light source passes successively through at least one of the first segments of the first LC display and through at least one of the second segments of the second LC display, thereby forming a plurality of resulting segments corresponding to superpositions of at least one first segment with at least one second segment.

4. The lighting device of claim 1, wherein the longitudinal directions of all first segments are aligned parallel to one another and/or the longitudinal directions of all second segments are aligned parallel to one another.

5. The lighting device of claim 1, wherein the longitudinal direction of the first segments forms an angle between 10° and 170° with the longitudinal direction of the second segments.

6. The lighting device of claim 1, wherein the first segments are strip-shaped, extending in their longitudinal direction over an entire active surface of the first LC display, and/or the second segments are strip-shaped, extending in their longitudinal direction over an entire active surface of the second LC display.

7. The lighting device of claim 1, wherein the first segments and/or the second segments have a non-strip shape.

8. The lighting device of claim 1, wherein the first and second LC displays are rotatable relative to one another such that an angle between the longitudinal direction of the first segments and the longitudinal direction of the second segments is adjustable.

9. The lighting device of claim 3, wherein at a first angle between the longitudinal directions of the first and second segments the resulting segments have a first shape, and at a second angle different from the first angle the resulting segments have a second shape different from the first shape.

10. The lighting device of claim 8, wherein the first shape is a rectangle and the second shape is a parallelogram.

11. The lighting device of claim 1, wherein each of the first and second LC displays comprises a liquid crystal layer arranged between two mutually opposite, at least partially transparent panes.

12. The lighting device of claim 11, wherein three at least partially transparent panes are provided, wherein the liquid crystal layer of the first LC display is arranged between a first pane and a second pane, and the liquid crystal layer of the second LC display is arranged between the second pane and a third pane, and wherein the exit surface of the first LC display and the entry surface of the second LC display are formed on the second pane.

13. The lighting device of claim 11, wherein four at least partially transparent panes are provided, wherein the liquid crystal layer of the first LC display is arranged between a first pane and a second pane, and the liquid crystal layer of the second LC display is arranged between a third pane and a fourth pane, and wherein a connecting material is arranged between the second pane and the third pane.

14. The lighting device of claim 1, wherein each of the LC displays is a passive LC display.

15. The lighting device of claim 1, wherein each of the LC displays is doped with color pigments.
